(19) United States
(12) Patent Application Publication
(10) Pub. No.: US 2011/0216191 A1
(43) Pub. Date: Sep. 8, 2011

(54) SYSTEM AND METHODS FOR EFFICIENT INSTALLATION OF SURVEILLANCE SYSTEMS AND FOCUS TOOL SYSTEM

(76) Inventor: Alan W. Davis, Houston, TX (US)

(21) Appl. No.: 12/716,051

(22) Filed: Mar. 2, 2010

(51) Int. Cl. H04N 7/18

(52) U.S. Cl. 348/143; 348/E07.085

(57) ABSTRACT

A system and method for the installation of surveillance systems and a focus tool system. In operation, a focus tool is coupled to a camera. The focus tool provides power to the camera. Through the focus tool, a user can view the image provided by the video camera make adjustments, including position and focus adjustments, to the camera. The focus tool may include a PoE network interface controller. The focus tool provides power to the camera and also includes a communications link for receiving images that are captured by the camera. The images from the camera are displayed on a screen at the focus tool.

### TECHNICAL FIELD The present disclosure relates generally to surveillance systems, and, more particularly, to a system and methods for efficiently installing surveillance systems.

### BACKGROUND

Video surveillance systems are commonly used to detect incidents that a user may deem desirable. For instance, surveillance systems may be used at banks, stores and homes. Typically, a user installs a camera at a desired location and the images captured by the camera are communicated to a monitor or a recording device. The user may then view the transmitted images. The images may be communicated from the camera to the recording device or a monitor through a wired or wireless network.

Modern video surveillance systems may include one or more IP cameras. IP cameras capture and send video footage over an IP network, allowing users to view, record, store and manage their video surveillance images either locally or remotely over a network infrastructure. IP cameras can be placed anywhere there is an IP network connection. In addition to streaming video footage, IP cameras may include other functionalities such as, for example, pan/tilt/zoom operation, motion detection, audio surveillance, integration with alarms, automated alerts, and intelligent video analytics.

IP cameras are often powered using Power of Ethernet (“PoE”) technology. PoE technology allows electrical power to be sent to the camera along with data on Ethernet cabling. When installing a surveillance system, a technician on the field will typically install an IP camera at a desired location. During installation, the IP camera is connected to an IP-based network, such as the Ethernet, which may supply power to the camera and allow the transmission of images from the camera to a receiving device for viewing and/or recording. The receiving device is often remotely located. Once the camera is powered up, the installing technician needs to make sure that the camera can capture images from a desired location and that the images captured by the camera are in focus. Currently, the technician on the field would need the assistance of another technician who is at the receiving location and can view the images captured by the camera. The two technicians will typically go through a number of iterations with the technician at the receiving location instructing the installing technician on how to move and/or change the focus of the camera based on what is viewed at the receiving location. This process is labor intensive and time consuming.

### SUMMARY

The present disclosure concerns a system and method for the installation of surveillance systems and a focus tool system. In operation, a focus tool is coupled to a camera. The focus tool provides power to the camera. Through the focus tool, a user can view the image provided by the video camera make adjustments, including position and focus adjustments, to the camera. The focus tool may include a PoE network interface controller. The focus tool provides power to the camera and also includes a communications link for receiving images that are captured by the camera. The images from the camera are displayed on a screen at the focus tool.

One advantage of the present disclosure is that a user can manage a camera remotely, without the need for a a second technician to be available to view the results of the adjustment process through the surveillance system. Another advantage of the focus tool system disclosed herein is that the focus tool supplies power to the camera, thereby avoiding the need for the camera to be separately powered for the sake of focusing or otherwise adjusting the camera. The focus tool may also include an operating system and storage, allowing the user of the focus tool to capture images on the focus tool. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts the installation of a surveillance camera in accordance with the prior art;

FIG. 2 depicts the installation of a surveillance camera using a focus tool in accordance with an exemplary embodiment of the present invention;

FIG. 3 is a close up view of the focus tool of FIG. 2; and

FIG. 4 is a block diagram of the focus tool of FIG. 2, in accordance with an exemplary embodiment of the present invention.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

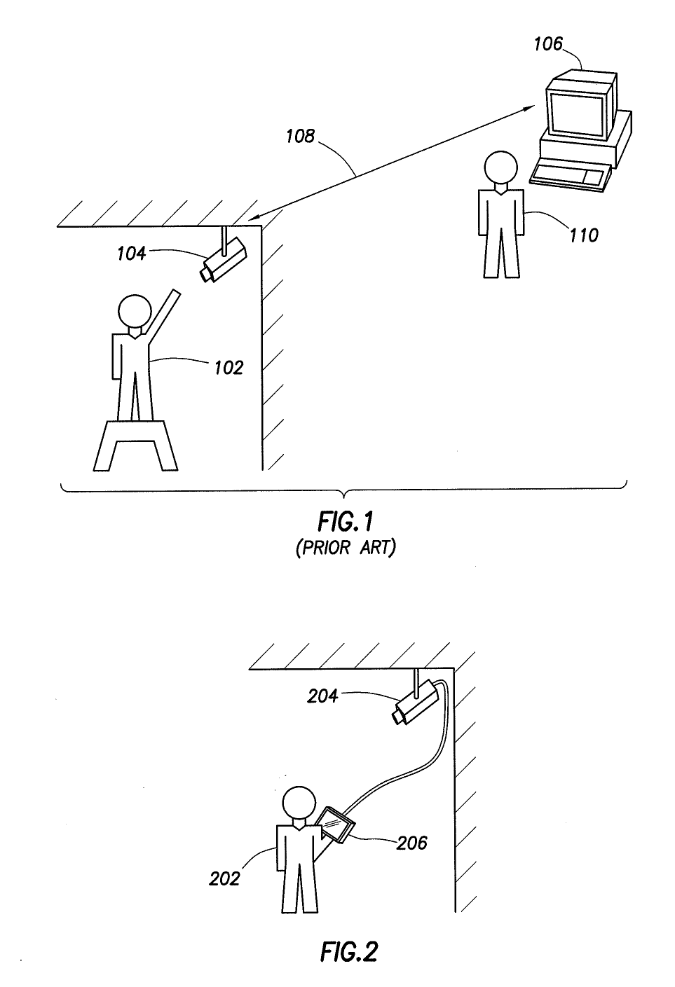

Shown in FIG. 1 is the typical process for the installation of a surveillance camera. A first technician 102 is located at the desired location to be monitored. The technician 102 physically installs the camera 104. During the installation process the camera 104 may be connected to a receiving device 106 through a wired or wireless network 108. The receiving device 106 may be an information handling system that is located at the installation site or at a remote location. The camera 104 may be powered by the PoE technology. The installing technician 102 would then communicate with the viewing technician 110 who is at the receiving device 106 and can view the images captured by the camera 104. Specifically, the viewing technician 110 would have to inform the installing technician whether and how the camera 104 needs to be moved or if and how the focus of the camera 104 should be adjusted to optimize the images received at the receiving device 106.

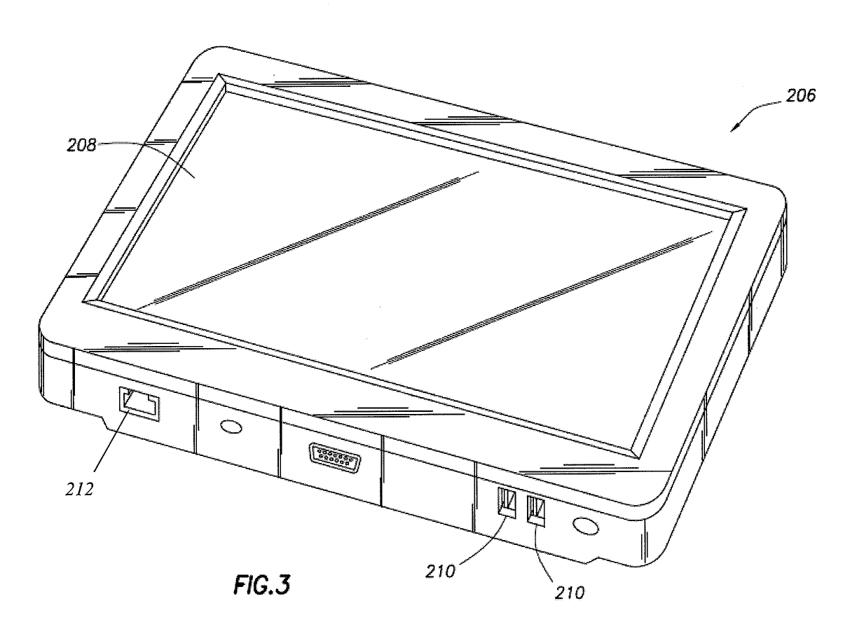

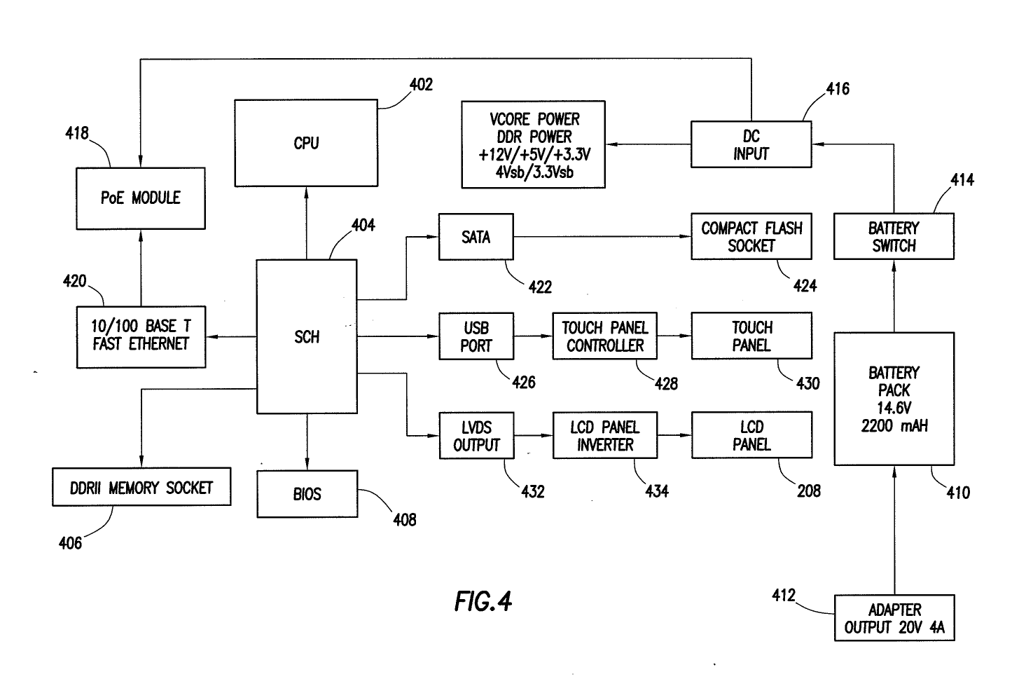

FIG. 2 shows the installation of a surveillance camera using a focus tool in accordance with an exemplary embodiment of the present invention. Specifically, the installing technician 202 can connect the camera 204 to a focus tool 206 in accordance with the present invention. The operation of the focus tool 206 will be discussed in more detail in conjunction with FIGS. 3 and 4. The focus tool 206 will deliver the necessary power to turn the camera 204 on. Additionally, the installing technician 202 can view the images captured by the camera 204 on the focus tool 206 and can adjust the position and/or focus of the camera 204 based on what he is viewing on the focus tool 206. Accordingly, using the focus tool 206 eliminates the need for a second technician at a receiving device who can instruct the installing technician on how to move and/or change the focus of the installed camera 204, making the process cheaper and more time efficient.

Turning now to FIG. 3, a focus tool 206 is depicted in more detail. The focus tool 206 is a self contained, battery powered information handling system. In one embodiment, the focus tool 206 may include a PoE Network Interface Controller (“NIC”). The focus tool 206 allows a user to power a PoE camera and focus it using images captured onto a built in screen 208. In one embodiment, the screen 208 may be a touch screen. In one embodiment, the focus tool 206 may include a data storage system (now shown) and allow a user to save images captured by the camera 204 to the data storage device. In another exemplary embodiment, an operating system may be installed in the focus tool 206 and the focus tool 206 may be used to perform a number of tasks such as preparing and/or editing documents. The focus tool may include one or more USB ports 210 for connection to peripheral devices such as a mouse, external memory, etc. Additionally, the focus tool 206 may include a PoE output 212 which is connectable to the camera being installed.

FIG. 4 is a block diagram of the focus tool 206 in accordance with an exemplary embodiment of the present invention. The focus tool 206 includes a Central Processing Unit (“CPU”) 402 which carries out the instructions necessary for the operation of the system. The CPU 402 is connected to a System Controller Hub (“SCH”) 404. A memory socket 406 and a Basic Input/Output System (“BIOS”) 408 are connected to the SCH 404. A battery 410 supplies power to the focus tool 206 and may be charged by the adapter 412. A battery switch 414 controls power deliver to the DC input 416 which supplies power to the PoE module 418. The SCH 404 is also communicatively coupled to the PoE module 418 through an Ethernet Network Interface 420.

Additionally, the SCH 404 may be connected to a Serial Advanced Technology Attachment (“SATA”) 422 computer bus which allows for connection to mass storage devices such as hard disk drives and/or optical drives. The SATA 422 may in turn be connected to a compact flash socket 424. Additionally, the SCH 404 may be connected to a USB port 426 which is connected to a touch panel controller 428. The touch panel controller 428 controls the touch panel 430. A Low-Voltage Differential Signaling (“LVDS”) output 432 is provided for the SCH 404. The LVDS output 432 is connected to an LCD inverter 434 which connects to the LCD panel 208.

Although the present disclosure has been described in detail, it should be understood that various changes, substitutions, and alterations can be made hereto without departing from the spirit and the scope of the invention as defined by the appended claims.

What is claimed is:

1. A method of installing a surveillance camera comprising:
Installing the surveillance camera at a desired location;
coupling the surveillance camera to a focus tool;
wherein the focus tool is located at the same location as the surveillance camera;
wherein the focus tool supplies power to the surveillance camera;
wherein the focus tool displays an image captured by the surveillance camera;
powering up the surveillance camera with the focus tool;
viewing the image captured by the surveillance camera on the focus tool; and
adjusting the surveillance camera based on the image displayed on the focus tool.

2. A surveillance camera installation system comprising:
a surveillance camera;
wherein the surveillance camera comprises a camera port;
wherein the camera port is operable to transmit an image captured by the camera;
wherein power is supplied to the surveillance camera through the camera port; and
a focus tool located in the same location as the surveillance camera;
wherein the focus tool is connected to the camera port;
wherein the focus tool supplies power to the surveillance camera; and
wherein the focus tool displays the image captured by the surveillance camera.

3. A method of installing a surveillance camera comprising:
installing the surveillance camera at a desired location;
coupling the surveillance camera to a focus tool;
wherein the focus tool is proximate to the surveillance camera;
wherein the focus tool supplies power to the surveillance camera;
wherein the focus tool displays an image captured by the surveillance camera;
powering up the surveillance camera with the focus tool;
viewing the image captured by the surveillance camera on the focus tool; and
adjusting the surveillance camera based on the image displayed on the focus tool.
